(19) United States
(12) Patent Application Publication
(10) Pub. No.: US 2014/0195560 A1
(43) Pub. Date: Jul. 10, 2014

(54) TWO WAY LOCAL FEATURE MATCHING TO IMPROVE VISUAL SEARCH ACCURACY

(71) Applicant: Samsung Electronics Co., LTD, Suwon-si (KR)

(72) Inventors: Xin Xin, Richardson, TX (US); Zhu Li, Plano, TX (US); Abhishek Nagar, Garland, TX (US); Gaurav Srivastava, Dallas, TX (US); Zhan Ma, San Jose, CA (US); Kong Posh Bhat, Plano, TX (US); Felix Carlos Fernandes, Plano, TX (US)

(73) Assignee: Samsung Electronics Co., LTD, Suwon-si (KR)

(21) Appl. No.: 14/060,314

(22) Filed: Oct. 22, 2013

Related U.S. Application Data
(60) Provisional application No. 61/750,684, filed on Jan. 9, 2013.
(60) Provisional application No. 61/812,646, filed on Apr. 16, 2013.
(60) Provisional application No. 61/859,037, filed on Jul. 26, 2013.

(51) Int. Cl. G06F 17/30

(52) U.S. Cl. CPC G06F 17/30277
USPC 707/772

(57) ABSTRACT

To improve precision of visual search processing, SIFT points within a query image are forward matched to features in each of a plurality of repository images and SIFT points within each repository image are backward matched to features within the query image. Forward-only, backward-only and forward-and-backward matches may be weighted differently in determining an image match. Two way matching may be triggered by query image bit rate in excess of a threshold or by a sum of weighted distances between matching points exceeding a threshold. Significant performance gains in eliminating false positive matches are achieved.

### CROSS-REFERENCE TO RELATED APPLICATIONS AND CLAIM OF PRIORITY

This application hereby incorporates by reference U.S. Provisional Patent Application No. 61/750,684, filed Jan. 9, 2013, entitled “TWO WAY LOCAL FEATURE MATCHING TO IMPROVE VISUAL SEARCH ACCURACY,” U.S. Provisional Patent Application No. 61/812,646, filed Apr. 16, 2013, entitled “TWO WAY LOCAL FEATURE MATCHING TO IMPROVE VISUAL SEARCH ACCURACY,” and U.S. Provisional Patent Application Ser. No. 61/859,037, filed Jul. 26, 2013, entitled “TWO WAY LOCAL FEATURE MATCHING TO IMPROVE VISUAL SEARCH ACCURACY.”

### TECHNICAL FIELD

The present disclosure relates generally to image matching during processing of visual search requests and, more specifically, to improving feature matching accuracy during processing of a visual search request.

### BACKGROUND

Mobile query-by-capture applications (or “apps”) are growing in popularity. Snap Tell is a music, book, video or video game shopping app that allows searching for price comparisons based on a captured image of the desired product. Vuforia is a platform for app development including vision-based image recognition. Google and Baidu likewise offer visual search capabilities.

In general, the performance of processing visual search requests is very dependent upon the quality of point matching. In particular, the need to avoid false positive matches during processing visual search requests can dramatically increase the number of points that must be correlated in order to reliably determine a match.

There is, therefore, a need in the art for improved visual search request processing.

### SUMMARY

To improve precision of visual search processing, SIFT points within a query image are forward matched to features in each of a plurality of repository images and SIFT points within each repository image are backward matched to features within the query image. Forward-only, backward-only and forward-and-backward matches may be weighted differently in determining an image match. Two way matching may be triggered by query image bit rate in excess of a threshold or by a sum of weighted distances between matching points exceeding a threshold. Significant performance gains in eliminating false positive matches are achieved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high level diagram illustrating an exemplary wireless communication system within which visual query processing with two way local feature matching to improve accuracy may be performed in accordance with various embodiments of the present disclosure;

FIG. 1A is a high level block diagram of the functional components of the visual search server from the network of FIG. 1;

FIG. 1B is a front view of wireless device from the network of FIG. 1;

FIG. 10 is a high level block diagram of the functional components of the wireless device of FIG. 1B;

FIG. 2 illustrates, at a high level, the overall compact descriptor visual search pipeline exploited within a visual search server in accordance with embodiments of the present disclosure;

FIGS. 3A, 3B and 3C illustrate visual query processing with two way local feature matching to improve accuracy in accordance with one embodiment of the present disclosure;

FIG. 4 is a high level flow diagram for a process of visual search query processing with two way local feature matching to improve accuracy in accordance with one embodiment of the present disclosure; and

FIGS. 5A and 5B are plots illustrating comparative results relating to visual search query processing with two way local feature matching to improve accuracy in accordance with one embodiment of the present disclosure.

### DETAILED DESCRIPTION

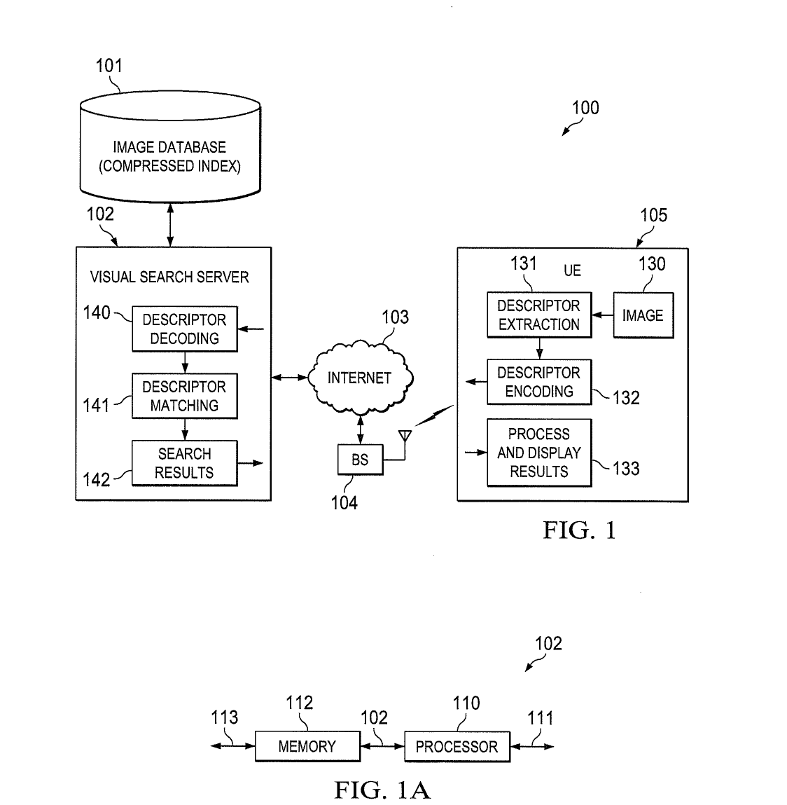

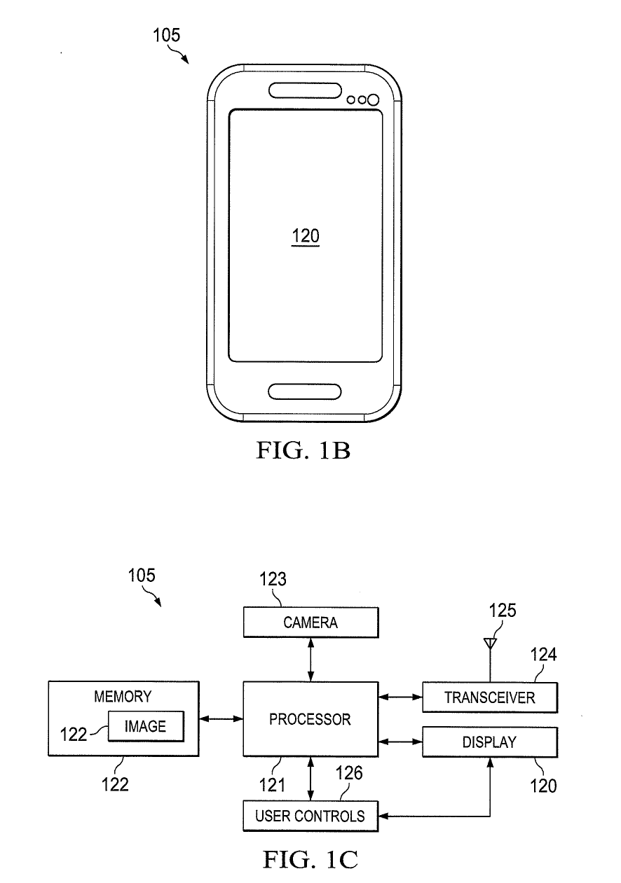

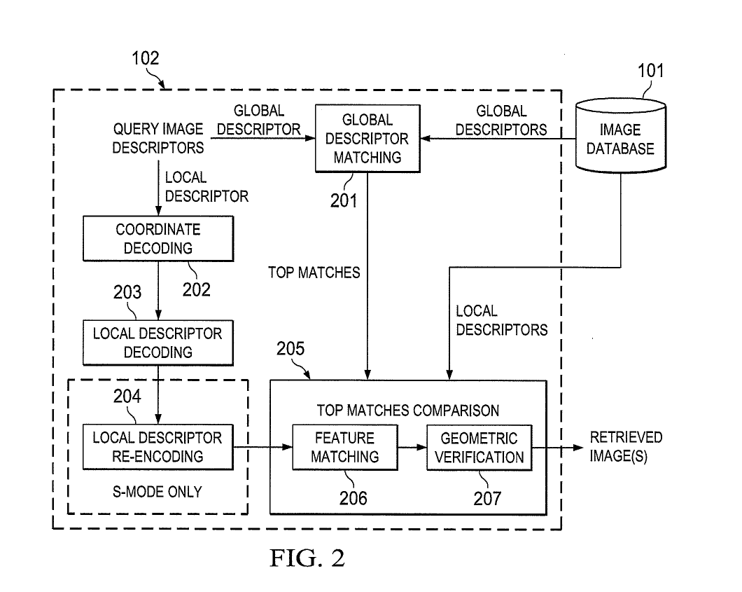

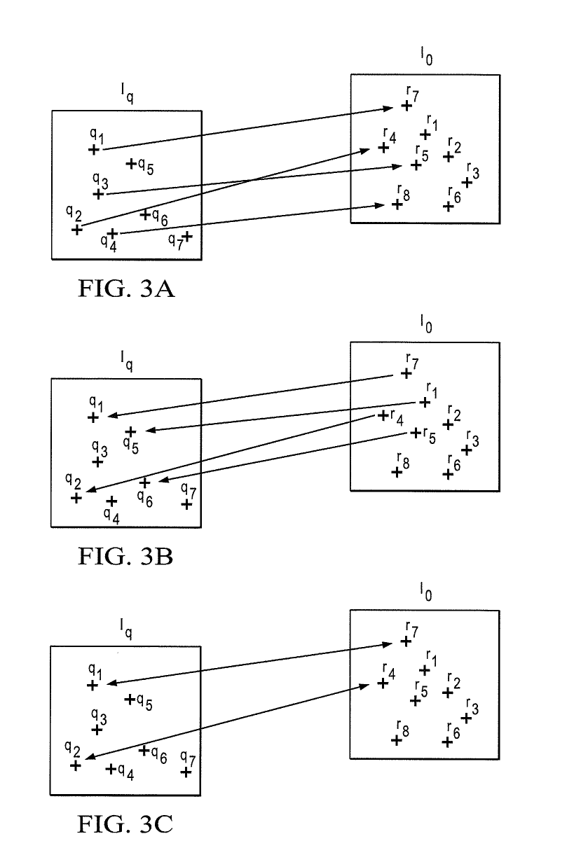

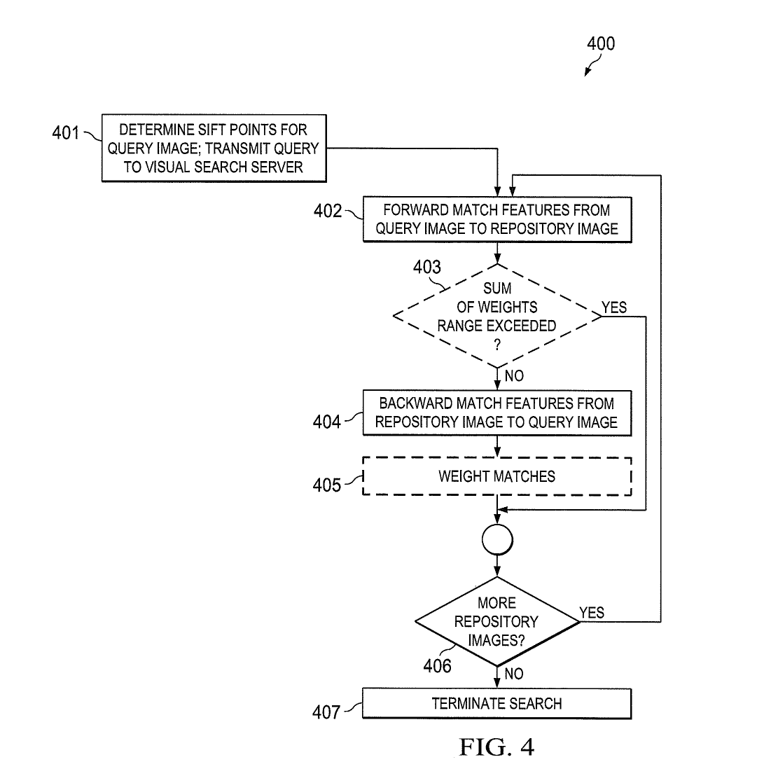

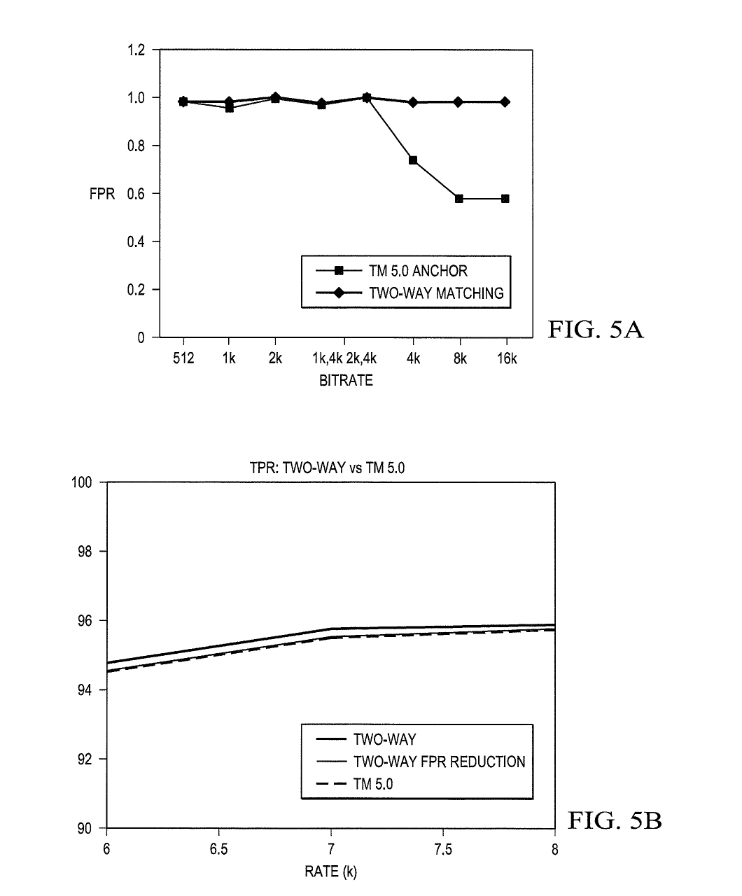

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:
[REF1]—Test Model 3: Compact Descriptor for Visual Search, ISO/IEC/JTC1/SC29/WG11/W12929, Stockholm, Sweden, July 2012;
[REF2]—CDVS, Description of Core Experiments on Compact descriptors for Visual Search, N12551, San Jose, Calif., USA: ISO/IEC JTC1/SC29/WG11, February 2012;
[REF3]—ISO/IEC JTC1/SC29/WG11/M22672, Telecom Italia's response to the MPEG CfP for Compact Descriptors for Visual Search, Geneva, CH, November 2011;
[REF4]—CDVS, Evaluation Framework for Compact Descriptors for Visual Search, N12202. Turin, Italy: ISO/IEC JTC1/SC29/WG11, 2011;
[REF5]—CDVS Improvements to the Test Model Under Consideration with a Global Descriptor, M23938, San Jose, Calif., USA: ISO/IEC JTC1/SC29/WG11, February 2012;
[REF6]—IETF RFC5053, Raptor Forward Error Correction Scheme for Object Delivery;
[REF7]—Lowe, D. (2004), Distinctive Image Features from Scale-Invariant Keypoints, International Journal of Computer Vision, 60, 91-110;
[REF8]—Andrea Vedaldi, Brian Fulkerson: “Vlfeat: An Open and Portable Library of Computer Vision Algorithms,” ACM Multimedia 2010: 1469-1472; and
[REF9]—Tsai, S., Chen, D., Takacs, G., Chandrasekhar, V., Vedantham, R., Grzeszczuk, R., et al., “Fast geometric re-ranking for image-based retrieval,” Proceedings of the IEEE International Conference on Image Processing, 2010.

Mobile visual search using Content Based Image Recognition (CBIR) and Augmented Reality (AR) applications are gaining popularity, with important business values for a variety of players in the mobile computing and communication fields. One key technology enabling such applications is a compact image descriptor that is robust to image recapturing variations and efficient for indexing and query transmission over the air. As part of on-going Motion Picture Expert Group (MPEG) standardization efforts, definitions for Compact Descriptors for Visual Search (CDVS) are being promulgated (see [REF1] and [REF2]).

FIG. 1 is a high level diagram illustrating an exemplary network within which visual query processing with two way local feature matching to improve accuracy may be performed in accordance with various embodiments of the present disclosure. The network 100 includes a database 101 of stored global descriptors regarding various images (which, as used herein, includes both still images and video), and possibly the images themselves. The images may relate to geographic features such as a building, bridge or mountain viewed from a particular perspective, human images including faces, or images of objects or articles such as a brand logo, a vegetable or fruit, or the like. The database 101 is communicably coupled to (or alternatively integrated with) a visual search server data processing system 102, which processes visual searches in the manner described below. The visual search server 102 is coupled by a communications network, such as the Internet 103 and a wireless communications system including a base station (BS) 104, for receipt of visual searches from and delivery of visual search results to a user device 105, which may also be referred to as user equipment (UE) or a mobile station (MS). As noted above, the user device 105 may be a “smart” phone or tablet device capable of functions other than wireless voice communications, including at least playing video content. Alternatively, the user device 105 may be a laptop computer or other wireless device having a camera or display and/or capable of requesting a visual search.

FIG. 1A is a high level block diagram of the functional components of the visual search server from the network of FIG. 1, while FIG. 1B is a front view of wireless device from the network of FIG. 1 and FIG. 1C is a high level block diagram of the functional components of that wireless device.

Visual search server 102 includes one or more processor(s) 110 coupled to a network connection 111 over which signals corresponding to visual search requests may be received and signals corresponding to visual search results may be selectively transmitted. The visual search server 102 also includes memory 112 containing an instruction sequence for processing visual search requests in the manner described below, and data used in the processing of visual search requests. The memory 112 in the example shown includes a communications interface for connection to image database 101.

User device 105 is a mobile phone and includes an optical sensor (not visible in the view of FIG. 1B) for capturing images and a display 120 on which captured images may be displayed. A processor 121 coupled to the display 120 controls content displayed on the display. The processor 121 and other components within the user device 105 are either powered by a battery (not shown), which may be recharged by an external power source (also not shown), or alternatively by the external power source. A memory 122 coupled to the processor 121 may store or buffer image content for playback or display by the processor 121 and display on the display 120, and may also store an image display and/or video player application (or “app”) 122 for performing such playback or display. The image content being played or displayed may be captured using camera 123 (which includes the above-described optical sensor) or received, either contemporaneously (e.g., overlapping in time) with the playback or display or prior to the playback/display, via transceiver 124 connected to antenna 125—e.g., as a Short Message Service (SMS) “picture message.” User controls 126 (e.g., buttons or touch screen controls displayed on the display 120) are employed by the user to control the operation of mobile device 105 in accordance with known techniques.

Referring back to FIG. 1, in the exemplary embodiment, image content 130 within mobile device 105 is processed by processor 121 to generate visual search query image descriptor(s). Thus, for example, a user may capture an image of a landmark (such as a building) and cause the mobile device 105 to generate a visual search relating to the image. The processor 121 within mobile device 105 includes descriptor extraction functionality 131 to perform image keypoint feature identification and description (keypoint spatial information coding), as well as descriptor encoding functionality 132 for encoding the descriptors and query compression for transmission as part of a visual search request. The visual search request is then transmitted over the network 100 to the visual search server 102. Notably, the visual search server 102 may be directly coupled to or integrated within base station 104, such that only transmission of the visual search request (and, later, results) over the wireless communications channel depicted in FIG. 1 is required.

The visual search server 102 receives the visual search request over the communications channel(s) of network 100, and includes descriptor decoding functionality 140 for decoding the query image descriptors within the visual search request. Descriptor matching functionality 141 provides two-way matching of local features between the query image and repository images within database 101 as described in further detail below, and search results functionality 142 returns information regarding the matching repository image(s), if any, over the communications channel(s) of network 100 to the mobile device 105. Results processing and display functionality 133 within the mobile device 105 receives the search results from the visual search server 102 and displays information regarding those results (which may be the matching image(s) themselves or merely descriptors identifying the content of the query image) to the user.

Among the objectives in implementing a visual search process should be front end real time performance accommodating, for example 640×480 pixel images at 30 frames per second (fps) for video, a low bit rate over the air achieving 100× compression with respect to the images forming the basis of a search request or 10× compression of the raw feature information, greater than 95% accuracy in pair-wise matching (verification) of a search image and greater than 90% precision in correct identification of the matching image(s), and indexing and search efficiency allowing a real time backend response from an image repository including as many as 100 million images.

FIG. 2 illustrates, at a high level, the overall compact descriptor visual search pipeline exploited within a visual search server in accordance with embodiments of the present disclosure. Rather than transmitting an entire image to the visual search server 102 for deriving a similarity measure known images, the mobile device 105 transmits only descriptors of the image, which may include one or both of global descriptors such as the color histogram and texture and shape features extracted from the whole image and/or local descriptors, which are extracted using (for example) Scale Invariant Feature Transform (SIFT) or Speeded Up Robust Features (SURF) from feature points detected within the image and are preferably invariant to illumination, scale, rotation, affine and perspective transforms.

Key to mobile visual search and AR applications is use of compact descriptors that are robust to image recapturing variations (e.g., from slightly different perspectives) and efficient for indexing and query transmission over the air, an area that is part of on-going Motion Picture Experts Group (MPEG) standardization efforts. In a CDVS system, visual queries include two parts: global descriptors and local descriptors for distinctive image regions (or points of interest) within the image and the associated coordinates for those regions within the image. A local descriptor includes of a selection of (for example) SIFT points [REF7] based upon local key point descriptors, compressed through a multi-stage visual query (VQ) scheme. A global descriptor is derived from quantizing the Fisher Vector computed from up to 300 SIFT points, which basically captures the distribution of SIFT points in SIFT space.

The matching of repository images with a query image during a visual query search may be processed in multiple stages or steps: In the first step, local features (e.g., SIFT points) from the query image are matched to one or more repository side images. If the number of matched SIFT points, n_sift_matched, is below a certain threshold, then two images are declared non-match pairs. Otherwise, geometric consistence between the matched SIFT points is checked, along with the global descriptor difference, and only when certain thresholds are crossed are the two images declared a matching pair.

In processing a query image, a short list of matches may be retrieved based on a global feature [REF5] that captures the local descriptor(s) distribution, using global descriptor matching 201 with global descriptors from image database 101. To ensure certain recall performance, this short list is usually large, with hundreds of images. Therefore, in the second step, local descriptors are utilized in a re-ranking process that will identify the true matches from the short list. Coordinate decoding 202 and local descriptor decoding 203 from the local descriptor from the image search query are determined, and the local descriptor re-encoding 204 may optionally be performed in software (S-mode) only. Top match comparison 205 from the short list of top matches in the global descriptor matching 201 is then performed using feature matching 206 and geometric verification 207, to determine the retrieved image(s) information. Obviously as the image database 101 size grows, especially in real world applications where repositories typically consists of billions of images, the short list will grow dramatically in size and the ultimate retrieval accuracy will depend upon the performance of the local feature based re-ranking.

The performance of a CVDS system is very dependent on the quality of SIFT point matches. While a one-way match process may be employed (comparing repository image SIFT points to those within the query image), the results produced can be un-robust, generating an unacceptably high number of false positive (FP) pairs for the query. To improve performance, the present disclosure introduces two-way SIFT point matching—first “forward,” between SIFT points in the query image and those in the repository image, and then “backward,” between SIFT points in a repository image and those in the query image—and verification before proceeding to determination of geometric consistency and global descriptor comparison to prune off inconsistence.

To address those disadvantages described above and to improve visual search performance, a two-way key point feature matching based solution is described. Given a pair of images, query image I_{q} and one repository image I₀ within the set of repository images I₀, I₁, . . . , Iᵣ, the task is to determine whether the pair is a matching pair or a non-matching pair—i.e., whether the two images contain the same visual object or set of objects, although the viewpoint, scale and/or orientation of the objects may be different in the two images. Such a matching is performed by using the SIFT point descriptors from the two images.

FIGS. 3A, 3B and 3C illustrate visual query processing with two way local feature matching to improve accuracy in accordance with one embodiment of the present disclosure. For a set of n local features (e.g., SIFT points) Q={q₁, q₂, . . . , qₙ} detected within a query image I_{q} in FIG. 3A and a set of m local features R={r₁, r₂, . . . , rₘ} detected within the repository image I₀, a match is performed from image I_{q} to I₀. That is, for every descriptor in the set Q, the set R is searched for a matching descriptor. Let the set of matching pairs thus obtained be Mf={mf₁, mf₂, . . . , mfₛ}, where mfᵢ={q,r} for qεQ and rεR. In the simplified example of FIGS. 3A-3C, four such “forward” matches are identified: {q₁,r₇}, {q₂,r₄}, {q₃,r₅} and {q₄,r₈}. Next a reverse matching is performed from repository image I₀ to query image I_{q} as depicted in FIG. 3B. Let the set of matching pairs thus obtained be Mb={mb₁, mb₂, . . . , mbₜ}, where mbᵢ={q,r} for qεQ and rεR. In the simplified example of FIGS. 3A-3C, four such “backward” matches are identified: {q₁,r₇}, {q₂,r₄}, {q₅,r₁} and {q₆,r₅}.

Given these sets, three different types of matches may be recognized:

Mf only: matches belonging to Mf that are not in Mb;

Mb only: Matches belonging to Mb that are not in Mf; and

Mf∩Mb: matches that belong to both Mf and Mb.

The last group is illustrated in FIG. 3C. Thus, in the exemplary process illustrated in FIGS. 3A through 3C, the descriptors {q₁, q₂} are two-way matched (indicated by the bi-directional arrows in FIG. 3C), {q₃, q₄} are one-way matched in the forward direction (indicated by the uni-directional arrows in FIG. 3A), and {r₁, r₅} are one-way matched in the reverse direction (indicated by the uni-directional arrows in FIG. 3B).

As compared to considering only the set of matches Mf, it is easy to see that the two-way matched descriptors, i.e., the matches in the set Mf∩Mb, should be more reliable in determining a “true” match (avoiding false positives) because that set satisfies both the forward matching and the reverse matching criterion. In the present disclosure, different weighted combinations of the sets of matches described above may be utilized according to the different image level matching criteria. In one scenario, referred to as a two-way only scenario, only the set of matches Mf∩Mb is used during query. In another scenario, referred to as a weighted two way scenario, the set of matches Mf∪Mb may be used while computing the final match score, with a higher weight assigned to the matches in Mf∩Mb as compared to Mf only matches and Mb only matches.

Note that in order to obtain the local descriptor matching score, first a geometric consistency check is performed using the Logarithmic Distance Ratio (LDR) approach [REF9]. The geometric consistency check provides a subset of matches that pass the check, referred to as inliers. The final matching score is computed as the sum of weights of each match among the inliers. In one approach, a weight of a match is computed as a function of distance between SIFT descriptors. In order to incorporate the two-way match information, these weights are post multiplied with a factor, such as a value 1 for the matches belonging to Mf∩Mb and a value of 0.5 for matches belonging to Mf only and Mb only sets.

If n and n are the number of SIFT descriptors in query and repository images I_{q} and I₀, the algorithmic complexity of two-way and two-way weighted SIFT matching is O(mn), which is the same as for the one-way match approach, adding only one additional (distance) sorting and inconsistent elimination. The two-way weighted scenario requires slightly more computation than two way only scenario since the geometric consistency check is performed on set Mf∩Mb, as Mb compared to just Mf in the two way only approach. Thus, the approached described above incurs no extraction time complexity penalty, no communication overhead and change to the bit stream for a search request, no memory cost, and no significant computational penalty.

In one embodiment of the present disclosure, the matches Mf are computed first and a coarse measure of the matching score Sw is estimated based on the individual matching scores of the matches in Mf. In our one such implementation, Sw is the sum of weights associated with each match which is computed as

$$Sw = \sum cos ( \frac{π}{2} * \frac{{d}_{1}}{{d}_{2}} ) ,$$

where d₁ is the distance of a keypoint in one image to the closest match in the second image and d₂ is the distance of the keypoint to the second closest match. The two way matching procedure may be performed only if Sw belongs to a certain range (e.g., [6,16] in one implementation). Otherwise, the baseline one-way matching is performed instead. This optimization significantly reduces the computational complexity of the technique.

Based on the experiments conducted on MPEG CDVS Test Model version 6.1, the retrieval results for weighted two-way scenario are provided in TABLE I below:

TABLE I

| | | | | | Proposed | | | | | |
|---|---|---|---|---|---|---|---|---|---|---|
| | | Anchor results | | | approach results | | | Difference | | |
| Dataset | Bitrate | MAP | TopMatch | Complexity | MAP | TopMatch | Complexity | MAP | TopMatch | Complexity |
| 1a | 512 | 80.15 | 87.47 | 0.9908 | 80.54 | 87.6 | 1.0905 | 0.39 | 0.13 | 0.0997 |
| | 1k | 85.48 | 92.4 | 1.2389 | 85.73 | 92.47 | 1.5711 | 0.25 | 0.07 | 0.3322 |
| | 2k | 88.81 | 95.07 | 1.2798 | 89.26 | 95.4 | 1.6914 | 0.45 | 0.33 | 0.4116 |
| | 4k | 90.76 | 95.8 | 1.728 | 90.87 | 96 | 2.0369 | 0.11 | 0.2 | 0.3089 |
| | 8k | 90.81 | 95.73 | 1.7216 | 91.05 | 95.87 | 2.3375 | 0.24 | 0.14 | 0.6159 |
| | 16k | 90.7 | 95.6 | 2.6035 | 90.96 | 95.73 | 2.6875 | 0.26 | 0.13 | 0.084 |
| 1b | 512 | 79.91 | 87.6 | | 80.14 | 87.4 | | 0.23 | −0.2 | |
| | 1k | 85.68 | 92.33 | | 85.72 | 92.73 | | 0.04 | 0.4 | |
| | 2k | 88.56 | 94.73 | | 88.84 | 94.8 | | 0.28 | 0.07 | |
| | 4k | 90.92 | 96 | | 91.05 | 95.8 | | 0.13 | −0.2 | |
| | 8k | 91.24 | 96.27 | | 91 | 96.07 | | −0.24 | −0.2 | |
| | 16k | 91.34 | 96.4 | | 91.07 | 96.13 | | −0.27 | −0.27 | |
| 1c | 512 | 76.52 | 83.93 | | 77.05 | 84.8 | | 0.53 | 0.87 | |
| | 1k | 82.27 | 89.53 | | 83.05 | 90.27 | | 0.78 | 0.74 | |
| | 2k | 85.81 | 92.93 | | 86.18 | 93.4 | | 0.37 | 0.47 | |
| | 4k | 88.6 | 94.27 | | 88.81 | 94.47 | | 0.21 | 0.2 | |
| | 8k | 89.18 | 94.67 | | 89.3 | 94.67 | | 0.12 | 0 | |
| | 16k | 89.4 | 94.67 | | 89.51 | 94.67 | | 0.11 | 0 | |
| 2 | 512 | 84.06 | 83.24 | | 84.26 | 83.79 | | 0.2 | 0.55 | |
| | 1k | 87.93 | 87.91 | | 88.06 | 87.91 | | 0.13 | 0 | |
| | 2k | 89.63 | 89.56 | | 89.31 | 89.29 | | −0.32 | −0.27 | |
| | 4k | 91.76 | 91.76 | | 91.76 | 91.76 | | 0 | 0 | |
| | 8k | 92.03 | 92.03 | | 92.03 | 92.03 | | 0 | 0 | |
| | 16k | 92.03 | 92.03 | | 92.03 | 92.03 | | 0 | 0 | |
| 3 | 512 | 90.59 | 90.25 | | 91.24 | 91 | | 0.65 | 0.75 | |
| | 1k | 92.27 | 92 | | 92.16 | 91.75 | | −0.11 | −0.25 | |
| | 2k | 93.54 | 93.5 | | 93.47 | 93.25 | | −0.07 | −0.25 | |
| | 4k | 94.9 | 94.75 | | 94.79 | 94.75 | | −0.11 | 0 | |
| | 8k | 95.38 | 95.25 | | 95.26 | 95.25 | | −0.12 | 0 | |
| | 16k | 95.58 | 95.5 | | 95.51 | 95.5 | | −0.07 | 0 | |
| 4 | 512 | 56.13 | 72.36 | | 56.38 | 72.45 | | 0.25 | 0.09 | |
| | 1k | 59.07 | 75.88 | | 59.63 | 76.02 | | 0.56 | 0.14 | |
| | 2k | 62.12 | 78.57 | | 62.66 | 79.02 | | 0.54 | 0.45 | |
| | 4k | 65.36 | 81.05 | | 65.86 | 81.34 | | 0.5 | 0.29 | |
| | 8k | 65.55 | 81.22 | | 65.86 | 81.28 | | 0.31 | 0.06 | |
| | 16k | 65.43 | 81.28 | | 65.57 | 80.79 | | 0.14 | −0.49 | |
| 5 | 512 | 65.86 | 80.82 | | 65.94 | 81.06 | | 0.08 | 0.24 | |
| | 1k | 69.78 | 84.35 | | 70.46 | 85.18 | | 0.68 | 0.83 | |
| | 2k | 74.73 | 89.14 | | 75.5 | 90.04 | | 0.77 | 0.9 | |
| | 4k | 76.97 | 90.24 | | 77.94 | 91.33 | | 0.97 | 1.09 | |
| | 8k | 77.58 | 90.98 | | 78.43 | 92.12 | | 0.85 | 1.14 | |
| | 16k | 77.33 | 90.75 | | 78.04 | 91.53 | | 0.71 | 0.78 | |
| | | | | | | | | 0.25 | 0.21 | 0.31 |

The matching results are provided in TABLE II below, where the columns “TPR” indicate a true positive match rate and the columns “FPR” indicate a false positive match rate:

TABLE II

| | | Anchor | | Proposed | | Difference | |
|---|---|---|---|---|---|---|---|
| Dataset | Bitrate | TPR | FPR | TPR | FPR | TPR | FPR |
| 1a | 4k | 97.5 | 1.65 | 97.43 | 1.61 | −0.07 | −0.04 |
| | 8k | 98.23 | 1.64 | 98.2 | 1.81 | −0.03 | 0.17 |
| | 16k | 98.4 | 1.39 | 98.43 | 1.47 | 0.03 | 0.08 |
| 1b | 4k | 97.43 | 1.67 | 97.4 | 1.55 | −0.03 | −0.12 |
| | 8k | 98.13 | 1.59 | 98.13 | 1.72 | 0 | 0.13 |
| | 16k | 98.33 | 1.3 | 98.4 | 1.44 | 0.07 | 0.14 |
| 1c | 4k | 96.97 | 1.44 | 96.9 | 1.43 | −0.07 | −0.01 |
| | 8k | 97.57 | 1.35 | 97.53 | 1.55 | −0.04 | 0.2 |
| | 16k | 97.9 | 1.17 | 98.03 | 1.2 | 0.13 | 0.03 |
| 2 | 4k | 97.53 | 0.69 | 97.8 | 0.69 | 0.27 | 0 |
| | 8k | 97.53 | 1.02 | 98.63 | 0.71 | 1.1 | −0.31 |
| | 16k | 97.53 | 1.73 | 97.53 | 1.68 | 0 | −0.05 |
| 3 | 4k | 99 | 0.48 | 99.25 | 0.43 | 0.25 | −0.05 |
| | 8k | 99.5 | 0.33 | 99.5 | 0.33 | 0 | 0 |
| | 16k | 99.5 | 0.35 | 99.25 | 0.35 | −0.25 | 0 |
| 4 | 4k | 82.6 | 0.8 | 82.9 | 0.77 | 0.3 | −0.03 |
| | 8k | 85.47 | 0.82 | 85.62 | 0.71 | 0.15 | −0.11 |
| | 16k | 86.62 | 0.92 | 86.52 | 0.88 | −0.1 | −0.04 |
| 5 | 4k | 90.55 | 0.16 | 90.59 | 0.16 | 0.04 | 0 |
| | 8k | 92.9 | 0.14 | 92.82 | 0.11 | −0.08 | −0.03 |
| | 16k | 93.49 | 0.08 | 93.73 | 0.08 | 0.24 | 0 |

| | | |
|---|---|---|
| Average | 0.090952 | −0.0019 |

Note that the two way matching is only activated for higher bit rates, e.g., 4 k-16 k, which can be performed with a specific software switch. The above matching results are obtained when the two way matching is selectively turned on based on the value of Sw. The two way matching can be selectively turned on based on another measure of matching scores of individual descriptors or any other quality or compatibility measure of the two images being matched.

FIG. 4 is a high level flow diagram for a process of visual search query processing with two way local feature matching to improve accuracy in accordance with one embodiment of the present disclosure. The exemplary process 400 depicted may performed partially (steps on the right side) in the processor 110 of the visual search server 102 and partially (steps on the left side) in the processor 121 of the client mobile handset 105. While the exemplary process flow depicted in FIG. 4 and described below involves a sequence of steps, signals and/or events, occurring either in series or in tandem, unless explicitly stated or otherwise self-evident (e.g., a signal cannot be received before being transmitted), no inference should be drawn regarding specific order of performance of steps or occurrence of the signals, or events, performance of steps or portions thereof or occurrence of signals or events serially rather than concurrently or in an overlapping manner, or performance of the steps or occurrence of the signals or events depicted exclusively without the occurrence of intervening or intermediate steps, signals or events. Moreover, those skilled in the art will recognize that complete processes and signal or event sequences are not illustrated in FIG. 4 or described herein. Instead, for simplicity and clarity, only so much of the respective processes and signal or event sequences as is unique to the present disclosure or necessary for an understanding of the present disclosure is depicted and described.

The process 400 begins with determination of SIFT points for query image, and transmission of the query to the visual search server (step 401). Forward matching of features for the query image to one of the repository images (step 402) is performed, optionally followed by a determination of whether the sum of weights Sw for the matches lies outside a predetermined range (step 403). If so, the process skips to a determination of whether additional repository images that have not been compared to the query image exists (step 406). If not, however, the process instead proceeds to backward matching of features from the repository image to the query image (step 404), and optionally to weighting of the forward-and-backward matches differently from the forward-only and backward-only matches (step 405) before determining if any repository images have not yet been compared (step 406). Once the query image features have been compared to the features of all repository images, the depicted portion of the overall visual search query processing terminates (step 407).

FIGS. 5A and 5B are plots illustrating comparative results relating to visual search query processing with two way local feature matching to improve accuracy in accordance with one embodiment of the present disclosure. FIG. 5A is a plot of TABLE III below, which reflects false positive rates (FPR) as a function of bitrate, with diamond shaped data points representing one-way matching on anchor data and square data points representing two-way matching on the same data.

TABLE III

| | | Average FPR (Two-Way |
|---|---|---|
| Descriptor Lengths | Average FPR (TM 5.0) | Matching) |
| 512 | 0.98 | 0.98 |
| 1k | 0.98 | 0.96 |
| 2k | 1.00 | 0.99 |
| 1k, 4k | 0.98 | 0.97 |
| 2k, 4k | 0.99 | 1.00 |
| 4k | 0.98 | 0.74 |
| 8k | 0.98 | 0.58 |
| 16k | 0.98 | 0.58 |

As shown, the elimination of the SIFT level false positive pairs translates into significant image level FPR improvement for higher rates. Lower bitrates do not provide enough local descriptors for this scheme to take effect. FIG. 5B is a plot of true positive rates (TPR) as a function of bitrate, indicating TPR gains of 0.25, 0.24, and 0.13 at 4 k, 8 k and 16 k bitrates, respectively. Combined one way and two way matching with weighting as described above achieves modest gains: 0.29% over all.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method, comprising:
receiving, at a visual search server having access to one or more repository images, information relating to distinctive features within a query image for a visual search request;
in the visual search server,
forward matching the distinctive features within the query image to distinctive features within each of the one or more repository images,
when selected criteria are met, backward matching distinctive features within the respective repository image to the distinctive features within the query image, and
determining whether each repository image correlates to the query image based upon results of matching distinctive features.

2. The method according to claim 1, wherein the backward matching is selectively performed when a sum of weights based upon distances in the forward matched distinctive features between the query image and the respective repository image exceed a threshold.

3. The method according to claim 1, wherein backward matching the distinctive features within the respective repository image to the distinctive features within the query image is performed for all of the repository images.

4. The method according to claim 1, wherein determining whether each repository image correlates to the query image based upon results of matching distinctive features involves considering only forward matching and backward matching distinctive features.

5. The method according to claim 1, wherein distinctive feature matches between the query image and one of the repository images used to determine an image match are weighted based upon whether the match is forward-matching only, backward-matching only, or both forward-matching and backward-matching.

6. The method according to claim 1, wherein the distinctive features within the query image and within the repository images are each Scale Invariant Feature Transform (SIFT) points.

7. The method according to claim 1, wherein only the forward matching is performed for query images corresponding to a bit rate less than a predetermined threshold, and the forward matching and the backward matching are performed for query images corresponding to a bit rate higher than the predetermined threshold.

8. A method, comprising:
receiving, at a visual search server having access to one or more repository images, information relating to distinctive features within a query image for a visual search request;
in the visual search server,
forward matching the distinctive features within the query image to distinctive features within each of the one or more repository images,
when at least one of (a) a sum of weights based upon distances in the forward matched distinctive features between the query image and the respective repository image, and (b) a bit rate for the query image is higher than the predetermined threshold, backward matching distinctive features within the respective repository image to the distinctive features within the query image, and
determining whether each repository image correlates to the query image based upon the forward matching and the backward matching.

9. The method according to claim 8, wherein distinctive feature matches between the query image and one of the repository images used to determine an image match are weighted based upon whether the match is forward-matching only, backward-matching only, or both forward-matching and backward-matching.

10. The method according to claim 8, wherein the distinctive features within the query image and within the repository images are each Scale Invariant Feature Transform (SIFT) points.

11. The method according to claim 10, wherein the SIFT points are described in the visual search request by local descriptors.

12. A visual search server system, comprising:
a network connection configured to provide access to one or more repository images and configured to receive information relating to distinctive features within a query image for a visual search request;
a processing system configured to
forward match the distinctive features within the query image to distinctive features within each of the one or more repository images,
when selected criteria are met, backward match distinctive features within the respective repository image to the distinctive features within the query image, and
determine whether each repository image correlates to the query image based upon results of matching distinctive features.

13. The visual search server system according to claim 12, wherein the backward matching is selectively performed when a sum of weights based upon distances in the forward matched distinctive features between the query image and the respective repository image exceed a threshold.

14. The visual search server system according to claim 12, wherein backward matching the distinctive features within the respective repository image to the distinctive features within the query image is performed for all of the repository images.

15. The visual search server system according to claim 12, wherein correlation of each repository image to the query image is determined by considering only forward matching and backward matching distinctive features.

16. The visual search server system according to claim 12, wherein distinctive feature matches between the query image and one of the repository images used to determine an image match are weighted based upon whether the match is forward-matching only, backward-matching only, or both forward-matching and backward-matching.

17. The visual search server system according to claim 12, wherein the distinctive features within the query image and within the repository images are each Scale Invariant Feature Transform (SIFT) points.

18. The visual search server system according to claim 12, wherein only the forward matching is performed for query images corresponding to a bit rate less than a predetermined threshold, and the forward matching and the backward matching are performed for query images corresponding to a bit rate higher than the predetermined threshold.

19. A visual search server, comprising:
a network connection configured to provide access to one or more repository images and to receive information relating to distinctive features within a query image for a visual search request;
a processing system configured to
forward match the distinctive features within the query image to distinctive features within each of the one or more repository images,
when at least one of (a) a sum of weights based upon distances in the forward matched distinctive features between the query image and the respective repository image, and (b) a bit rate for the query image is higher than the predetermined threshold, backward match distinctive features within the respective repository image to the distinctive features within the query image, and
determine whether each repository image correlates to the query image based upon the forward matching and the backward matching.

20. The visual search server system according to claim 19, wherein distinctive feature matches between the query image and one of the repository images used to determine an image match are weighted based upon whether the match is forward-matching only, backward-matching only, or both forward-matching and backward-matching.

21. The visual search server system according to claim 19, wherein the distinctive features within the query image and within the repository images are each Scale Invariant Feature Transform (SIFT) points.

22. The visual search server system according to claim 21, wherein the SIFT points are described in the visual search request by local descriptors.
